(19) United States
(12) Patent Application Publication
(10) Pub. No.: US 2013/0043627 A1
(43) Pub. Date: Feb. 21, 2013

(54) Crash pad with pelletized and shredded form filling

(71) Applicant: Young Chu, (US)

(72) Inventor: Young Chu, (US)

(21) Appl. No.: 13/199,098

(22) Filed: Aug. 19, 2011

(51) Int. Cl. A63B 6/00; F16F 7/00

(52) U.S. Cl. 267/141

(57) ABSTRACT

This present invention addresses the need for more shock-absorbing crash pad. Most traditional crash pads use box-type stiffer, thinner, closed-cell foam sheet over, sometimes under, too, a squishier, thicker, open-cell solid foam base. However, traditionally, most inner form are solid box type and still too hard to soften the landings in case of a fall of climber because most impact goes to downward. This present invention uses forms which were shredded and chunked to ¼″ to ½″ varied pieces packed in enclosed baffles instead of box-type solid form, allowing air among forms and more shock-absorbing baffle effect to minimize the impact to falling climbers. When hit by a falling climber, the impacts are dispersed to both side-way and downward minimizing the impact to the falling climber.

### FIELD OF THE INVENTION

This invention relates to crash pad or bouldering mat for bouldering or rock-climbing. More particularly, but not exclusively, it concerns a crash pad used by mountaineers or climbers to ensure their safety in case of fall.

### BACKGROUND OF THE INVENTION

Crash pad or bouldering mat is a foam pad used for protection when bouldering and climbing. There are various sizes and makes, but the most common type is a folded mattress, 2 to 6 inches thick (51 to 150 mm), that when unfolded measures about 3×4 feet (1 to 1.3 meters). Crash pads often have shoulder straps so as to easily move it between boulders.

Crash pad often comes in either dual or triple density foam inners to provide differing levels of support with the bottom or middle being the softer.

With the high density foam at the top, this will prevent the climber's foot from sinking through the foam and either gaining impact on the floor struck in the mat which would increase the chance of injury. Crash pads are often used to cover dangerous sections of the ground below a chosen climb such as protruding rocks or grass tufts.

Crash pad is a thick mat used to soften landings or cover objects that would be hazardous in the event of a fall.

Most crash pads use a stiffer, thinner, closed-cell foam sheet over, sometimes under, too, a squishier, thicker, open-cell foam base. The closed-cell foam disperses the force, so you don't sink through the softer open-cell.

Traditionally, most inner form are solid box type and still too hard to soften the landings in case of a fall because most impact goes to downward.

The object of the present invention is to provide more cushion to soften the landing by changing the inner box-type of solid foam to pelletized and shredded form filling packed in enclosed baffles. It is more shock-absorbing than the traditional box-type, and then removes unnecessary damage to the climbers because the impact goes to both side way and downward.

### SUMMARY OF INVENTION

This present invention addresses the need for more shock-absorbing crash pad. Most crash pads use a box-type stiffer, thinner, closed-cell foam sheet over, sometimes under, too, a squishier, thicker, open-cell foam base. However, traditionally, most inner form are solid box type and spreads most of the shock downward only in case of a fall. This present invention uses forms which were shredded and chunked to ¼″ to ½″ varied pieces packed in enclosed baffles, allowing the shock to spread both side way and downward to minimize the impact to falling climbers.

### BRIEF DESCRIPTION OF THE DRAWINGS

FIG. 1 presents side views of traditional box-type bouldering pad.

FIG. 2 presents how the impact goes when a climber falls on a box-type bouldering pad.

FIG. 3 presents a side view of Bouldering Mat with Shredded and Chunked Form.

FIG. 4 presents how the impact goes when a climber falls on a crash pad with Shredded and Chunked Form.

### DESCRIPTION OF PREFERRED EMBODIMENTS

In reference to FIGS. 1, the traditional crash pad 1 includes inner box-type form.

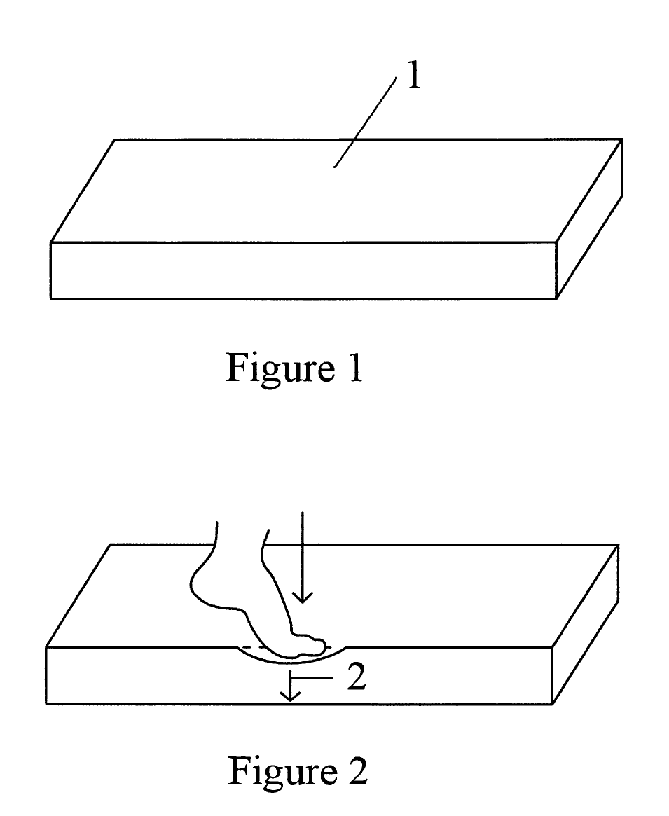

In reference to FIGS. 2, it shows the most impact 2 goes to downward and describes more impact to the feet and body of climbers.

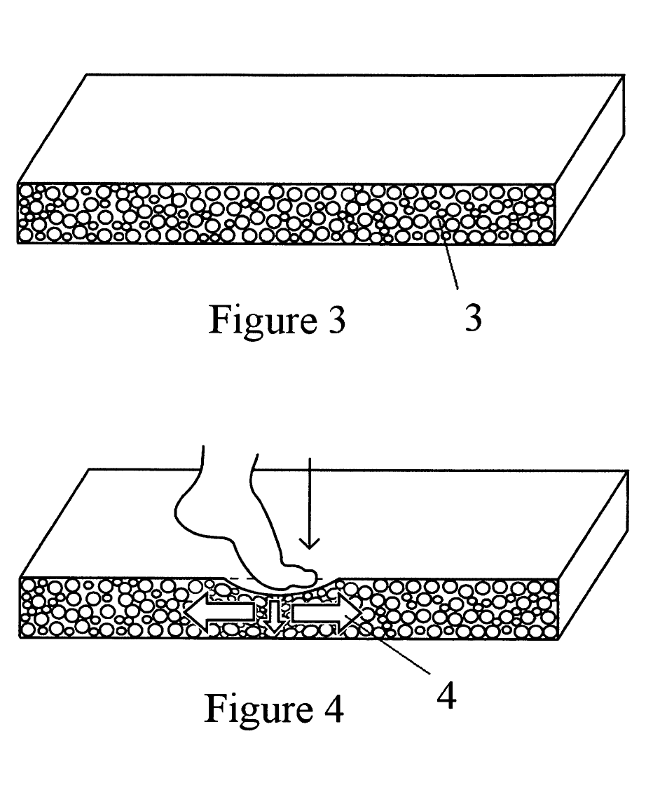

In reference to FIGS. 3, the present invention, crash pad with Shredded and Chunk Form includes many variety pieces of shredded and chunked form 4.

In reference to FIG. 4, the present invention, crash pad with Shredded and Chunk Form includes many variety pieces of shredded and chunked form 4. The baffle impact goes to both side-way and downward due to air among forms in packed with shredded and chunked forms dispersing the impact to both side way and downward.

What is claimed is:

1. A crash pad comprising many small pelletized and shredded form filling which were shredded and chunked to ¼″ to ½″ of varied pieces, and packed in enclosed baffles. The crash pad is filled with many small forms in size of ¼″ to ½″ allowing air among forms and more shock-absorbing impact to minimize the impact to climbers. This present invention uses forms which were shredded and chunked to ¼″ to ½″ varied pieces packed in enclosed baffles , allowing the shock to spread both side way and downward to minimize the impact to falling climbers.
